(19) United States
(12) Patent Application Publication
(10) Pub. No.: US 2015/0138076 A1
(43) Pub. Date: May 21, 2015

(54) COMMUNICATION DEVICE AND METHOD OF PROCESSING INCOMING CALL BY FACIAL IMAGE

(71) Applicant: HON HAI PRECISION INDUSTRY CO., LTD., New Taipei (TW)

(72) Inventor: HONG-SHENG CHEN, New Taipei (TW)

(21) Appl. No.: 14/546,171

(22) Filed: Nov. 18, 2014

(30) Foreign Application Priority Data
Nov. 18, 2013 (TW) 102141826

(51) Int. Cl. G06F 3/01; G06K 9/00; H04W 8/22

(52) U.S. Cl. CPC G06F 3/017; H04W 8/22; G06K 9/00302
USPC 345/156

(57) ABSTRACT

A communication device able to manage incoming calls by reference to a user's facial expression includes a storage unit, an image capturing unit, an image recognition unit, and an incoming call processing unit. The storage unit stores preset facial images associated with predetermined processing operations. The image capturing unit capturing images of the user's face when an incoming call is received and the image recognition unit matches captured images against preset facial images. When at least one of the captured images matches one of the at least one preset facial images, the incoming call processing unit executes a predetermined processing operation.

### CROSS-REFERENCE TO RELATED APPLICATIONS

This application claims priority to Taiwanese Patent Application No. 102141826 filed on Nov. 18, 2013, the contents of which are incorporated by reference herein.

### FIELD

Embodiments of the present disclosure generally relate to communications management, and more particularly, to a method of processing incoming calls received by a communication device by facial images.

### BACKGROUND

Telephone subscribers may receive an incoming telephone call by communication devices, such as smart phones. Generally, the incoming telephone call can be processed (e.g., accepted or rejected) by manual operations. For example, slide operation on touch screen of the smart phones and user gestures sensed by the smart phones can be used to process the incoming telephone call.

### BRIEF DESCRIPTION OF THE DRAWINGS

Implementations of the present technology will now be described, by way of example only, with reference to the attached figures.

FIG. 1 is block diagram of a communication device according to an exemplary embodiment.

FIG. 2 is a flowchart of one embodiment of a method of processing an incoming call received by the communication device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected.

The present disclosure is described in relation to a method of processing incoming calls received by a communication device by reference to facial images.

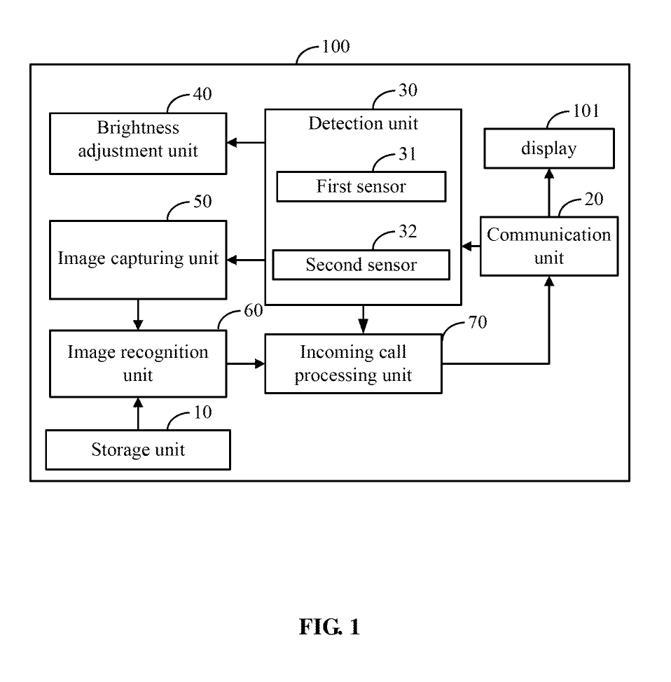

FIG. 1 illustrates a communication device 100 of the embodiment. In at least one embodiment, the communication device 100 can be a smart phone, a personal digital assistant (PDA), a video telephone, or other like device. In an exemplary embodiment, the communication device 100 can include a display 101, a storage unit 10, a communication unit 20, a detection unit 30, a brightness adjustment unit 40, an image capturing unit 50, an image recognition unit 60, and an incoming call processing unit 70. In at least one embodiment, the storage unit 10, the communication unit 20, the detection unit 30, the brightness adjustment unit 40, the image capturing unit 50, the image recognition unit 60, and the incoming call processing unit 70 can be coupled with each other, either by direct connection or indirect connection, for data exchange.

The storage unit 10 stores at least one preset facial image where each facial image is associated with a predetermined operation during a process of receiving an incoming call. In at least one embodiment, a first preset facial image and a second preset facial image are stored in the storage unit 10. Each of the first and second preset facial images represents information concerning a user of the communication device. In addition, each of the first and second preset facial images can include facial characteristics indicating expressions of the user (e.g., a frown, a smile, an expression of anger, or the user laughing). In at least one embodiment, each facial expression can be associated to an incoming call processing manner (e.g., accept or reject) to process an incoming call received by the communication device 100.

The communication unit 20 can establish a communication between the communication device 100 and external communication devices. In at least one embodiment, the communication unit 20 embedded in the communication device 100 can be a global system for mobile communication (GSM) module, a code division multiple access (CDMA) module, a wideband code division multiple access (WCDMA), a third generation (3G) module, or a fourth generation (4G) module. In this embodiment, the communication unit 20 is configured to detect an incoming call received from an external communication device. When an incoming call is received, the communication unit 20 displays information of the incoming call, such as the telephone number of the device making the incoming call, via the display 101.

When an incoming call is received by the communication device 100, the detection unit 30 is configured to detect an environmental brightness surrounding the communication device 100, and to detect the closeness of the user to the communication device 100. In at least one embodiment, the detection unit 30 includes a first sensor 31 to detect the environmental brightness and a second sensor 32 to detect proximity of any object in relation to the communication device 100. For example, the first sensor 31 can be luminance sensor while the second sensor 32 can be a proximity sensor. In at least one embodiment, when a distance between the user and the communication device 100 is less than a predetermined distance (such as within 10-50 cm), the user is determined to be physically close to the communication device 100.

When the value of the environmental brightness is less than a predetermined value, the first sensor 31 generates a first detection signal to activate the brightness adjustment unit 40 to increase illumination surrounding the communication device 100. In at least one embodiment, the brightness adjustment unit 40 can be a flash lamp installed at a side of the display 101, to enable the image capturing unit 50 to capture clearer images.

When the user is detected to be close to the communication device 100, the detection unit 30 generates a second detection signal to control the image capturing unit 50 to capture images of the scene in front of the image capturing unit 50. In at least one embodiment, the image capturing unit 50 can be a front camera or a backside camera of the communication device 100. The image capturing unit 50 is configured to capture images at regular intervals in response to the second detection signal. For example, the image capturing unit 50 can capture an image every 0.2 seconds until the incoming call processing has been completed, such as the incoming call being accepted, or being rejected, or being terminated after being accepted.

The image recognition unit 60 is configured to determine whether any captured image matches one of the at least one preset facial image. In at least one embodiment, when a captured image includes at least a predetermined proportion (e.g., 80%) of facial characteristics of one preset facial image, the captured image is determined to match with one preset facial image.

When at least one of the captured images matches one of the at least one preset facial image, the incoming call processing unit 70 executes a predetermined operation associated with the one of the at least one preset facial image, to process the incoming call. For example, if a captured image matches the first preset facial image, the incoming call processing unit 70 can allow the incoming call to be accepted. If the captured image matches the second preset facial image, the incoming call processing unit can reject the incoming call.

In another embodiment, a third preset facial image can be stored in the storage unit 10. If a captured image which matches the third facial image is captured after the incoming call has been accepted, the incoming call processing unit 70 can directly terminate the incoming call.

In other embodiments, if the incoming call has not been processed for a predetermined period of time, such as one minute, the incoming call processing unit 70 can directly terminate the incoming call or transfer the incoming call to another predetermined phone number.

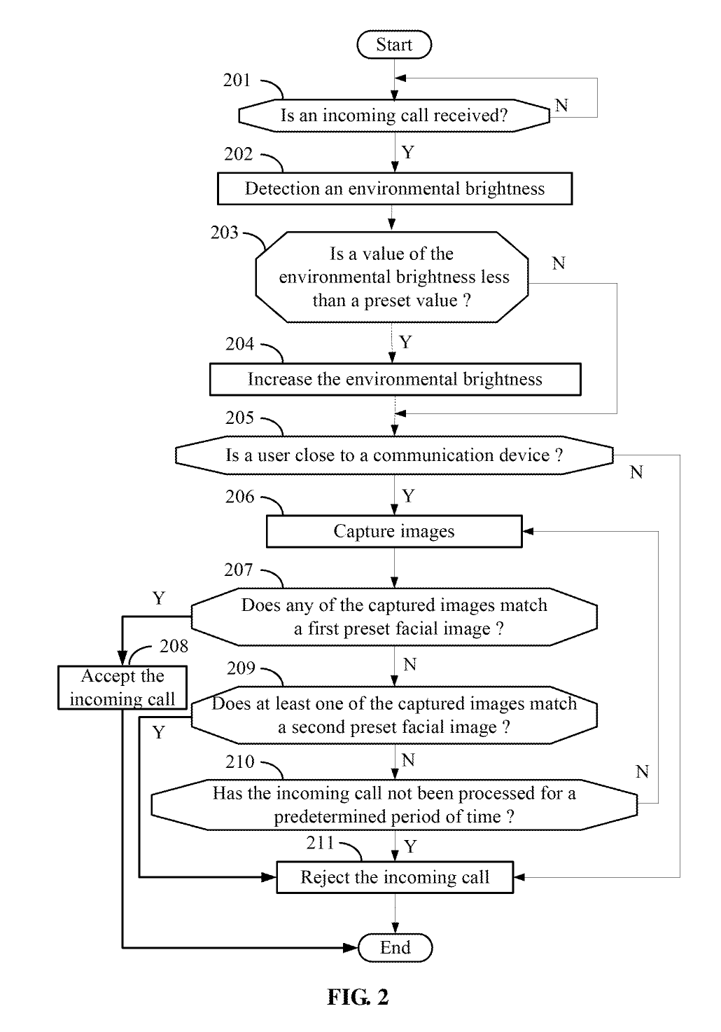

FIG. 2 illustrates a flowchart of an example method 200 of the disclosure. The method 200 is provided by way of example, as there are a variety of ways to carry out the method 200. The method 200 described below can be carried out using the functional units of the communication device 100 as illustrated in FIG. 1, for example, and various elements of this figure are referenced in explaining the example method 200. Each block shown in FIG. 2 represents one or more processes, methods, or subroutines which are carried out in the example method 200. Furthermore, the order of blocks is illustrative only and the order of the blocks can change. Additional blocks can be added or fewer blocks may be utilized without departing from the scope of this disclosure. The example method 200 can begin at block 201.

At block 201, a communication unit detects an incoming call to a communication device. When an incoming call is received, block 202 is implemented. Otherwise, the process remains in block 201.

At block 202, a detection unit detects an environmental brightness surrounding the communication device.

At block 203, the detection unit determines whether or not the value of the environmental brightness is less than a predetermined value. If the value of the environmental brightness is less than the predetermined value, block 204 is implemented. If the value of the environmental brightness is not less than the predetermined value, block 205 is implemented.

At block 204, a brightness adjustment unit is activated to increase the environmental brightness surrounding the communication device.

At block 205, the detection unit detects the closeness of a user in relation to the communication device within a predetermined time interval. If the user is detected to be close to the communication device, block 206 is implemented, otherwise the procedure goes to block 211.

At block 206, an image capturing unit is activated to capture images at regular intervals.

At block 207, an image recognition unit detects if one of the captured images matches a first preset facial image stored in a storage unit. If one of the captured images matches the first preset facial image, block 208 is implemented. Otherwise, block 209 is implemented.

At block 208, the incoming call is accepted by an incoming call processing unit and the procedure ends.

At block 209, the image recognition unit determines whether any captured image matches a second preset facial image stored in the storage unit. If at least one of the captured images matches the second preset facial image, block 211 is implemented. Otherwise, block 210 is implemented.

At block 210, the incoming call processing unit detects a non-processing of the incoming call for a predetermined period of time. If the incoming call has not been processed for the predetermined period of time, block 211 is implemented. Otherwise, the procedure returns to block 206.

At block 211, the incoming call is rejected by the incoming call processing unit.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A communication device comprising:
a storage unit storing at least one preset facial image, the preset facial image associated with a predetermined operation during a process of receiving an incoming call;
an image capturing unit configured to capture images of a scene in front of the image capturing unit;
an image recognition unit configured to determine whether an image captured by the image capturing unit matches the preset facial image; and
an incoming call processing unit configured to execute a predetermined operation associated with the preset facial image to process the incoming call upon the determination that the captured image matches the preset facial image.

2. The communication device according to claim 1, further comprising:
a detection unit configured to detect an environmental brightness surrounding the communication device when the incoming call is received by the communication device, and to generate a first detection signal when a value of the environmental brightness is less than a predetermined value; and
a brightness adjustment unit being activated by the first detection signal to increase the environmental brightness.

3. The communication device according to claim 2, wherein the detection unit is further configured to detect the closeness of a user in relation to the communication device when the incoming call is received, and to generate a second detection signal to activate the image capturing unit to capture the images when the user is detected to be close to the communication device.

4. The communication device according to claim 3, wherein the detection unit comprises a first sensor to detect the environmental brightness and a second sensor to detect proximity of any object in relation to the communication device.

5. The communication device according to claim 4, wherein the first sensor is a luminance sensor while the second sensor is a proximity sensor.

6. The communication device according to claim 1, wherein the at least one preset facial image comprise a first preset facial image and a second preset facial image.

7. The communication device according to claim 6, wherein when a captured image matches the first preset facial image, the incoming call processing unit accepts the incoming call.

8. The communication device according to claim 7, wherein when a captured image matches the second preset facial image, the incoming call processing unit rejects the incoming call.

9. The communication device according to claim 6, wherein the at least one preset facial image further comprise a third preset facial image; when an image matches the third facial image is captured after the incoming call has been accepted, the incoming call processing unit further terminates the incoming call.

10. The communication device according to claim 1, wherein when the incoming call has not been processed for a predetermined period of time, the incoming call processing unit transfers the incoming call to a predetermined phone number.

11. A method of processing an incoming call received by a communication device, comprising:
storing at least one preset facial image in a storage unit of the communication device, the facial image associated with a predetermined operation during a process of receiving an incoming call;
capturing, by an image capturing unit, of a scene in front of the image capturing unit;
determining whether a captured image matches the preset facial image; and
executing a predetermined operation associated with the preset facial image to process the incoming call when a captured image matches the preset facial image.

12. The method according to claim 11, further comprising:
detecting an environmental brightness surrounding the communication device when the incoming call is received by the communication device; and
activating a brightness adjustment unit of the communication device to increase the environmental brightness when a value of the environmental brightness is less than a preset value.

13. The method according to claim 12, further comprising:
detecting closeness of a user to the communication device when the incoming call is received, and activating the image capturing unit to capture the images when the user is detected to be close to the communication device.

14. The method according to claim 13, wherein the environmental brightness is detected by a luminance sensor and the closeness of the user to the communication device is detected by a proximity sensor.

15. The method according to claim 11, wherein the at least one preset facial image comprise a first preset facial image and a second preset facial image.

16. The method according to claim 15, wherein when a captured image matches the first preset facial image, the incoming call is accepted.

17. The method according to claim 15, wherein when a captured image matches the second preset facial image, the incoming call is rejected.

18. The method according to claim 15, wherein the at least one preset facial image further comprise a third preset facial image; when an image matches the third facial image is captured after the incoming call has been accepted, the incoming call is terminated.

19. The method according to claim 11, wherein when the incoming call has not been processed for a predetermined period of time, the incoming call is transferred to a predetermined phone number.
